(19) United States
(12) Patent Application Publication
(10) Pub. No.: US 2024/0138474 A1
(43) Pub. Date: May 2, 2024

(54) AEROSOLISATION MODULE

(71) Applicant: Philip Morris Products S.A., Neuchatel (CH)

(72) Inventors: Leander DITTMANN, Crissier (CH); Robert William EMMETT, Thame (GB); Laura GALLIMBERTI, Morges (CH)

(73) Assignee: Philip Morris Products S.A., Neuchatel (CH)

(21) Appl. No.: 18/546,673

(22) PCT Filed: Feb. 9, 2022
(86) PCT No.: PCT/EP2022/053160

§ 371 Date: Aug. 16, 2023

(30) Foreign Application Priority Data
Feb. 24, 2021 (EP) 21159050.0

(51) Int. Cl. A24F 40/05; A24F 40/10; A24F 40/485; B05B 17/00

(52) U.S. Cl. CPC A24F 40/05; A24F 40/10; A24F 40/485; B05B 17/0646; A24F 40/44

(57) ABSTRACT

An aerosol-generating device is provided, including: an elongate housing, and an aerosolisation module detachably insertable into the housing, the module including a vibratable transducer to aerosolise a liquid aerosol-forming substrate, electrical contacts in communication with the transducer to connect with corresponding contacts of the housing, and an electrically conductive membrane including an aerosol generation zone, the transducer coupled to the membrane to vibrate it, and a portion of the membrane forming electrical contacts of the module, the housing containing a power source and configured to detachably receive the module to establish a detachable electrical connection, a sidewall of the housing including an aperture defining an access opening to a cavity within the housing and containing the contacts, and the contacts of the housing and the module being configured such that insertion of the module into the cavity results in electrical connection between the contacts of the housing and the module.

The present disclose relates to an aerosolisation module for use with an aerosol-generating device. The present disclosure also relates to an aerosol-generating system or device including such an aerosolisation module. Additionally, the present disclosure relates to a kit of parts which, when assembled, forms an aerosol-generating device.

Known vibrating nebulizers for aerosolising a liquid aerosol-forming substrate employ a membrane having a distribution of nozzles. The membrane is coupled to a vibratable transducer, with the transducer fixedly coupled to a controller and power source of the nebuliser. An electrical signal provided to the transducer by the controller is converted to a vibratory output by the transducer, with this vibratory output inducing vibration of the membrane. On contact of the membrane with a liquid aerosol-forming substrate, the vibrating action of the membrane results in the liquid aerosol-forming substrate being pushed through the nozzles to form aerosol droplets. Vibration of the membrane serves to generate the aerosol droplets. In this manner, such known vibrating nebulizers provide for non-thermal generation of aerosol. As used herein, the term “non-thermal generation of aerosol” refers to aerosol droplets being formed from the liquid aerosol-forming substrate without requiring the addition of heat to the substrate. However, with continued use, the membrane of such a known vibrating nebulizer may become clogged with residue from the substrate or external contaminants. This residue may affect the quality of the aerosol droplet pattern produced by the membrane. Cleaning of the membrane to remove this residue can be difficult due to a number of reasons. For example, the membrane is typically a fragile structure and therefore may be difficult to clean without causing permanent damage to the membrane. Further, the membrane may also be difficult to access from outside of the nebuliser; for example, the membrane may be recessed within a housing of the nebuliser to protect the membrane from damage. These difficulties can result in a user disposing of a vibrating nebuliser which may be fully functional in all respects other than having residue on the membrane.

The present disclosure relates to provision of an aerosolisation module for use with an aerosol-generating device which addresses one or more of the problems described above.

According to an aspect of the present disclosure, there is provided an aerosolisation module detachably insertable in a housing of an aerosol-generating device. The aerosolisation module comprises a vibratable transducer for aerosolising a liquid aerosol-forming substrate, and one or more electrically-conductive contacts in electrical communication with the vibratable transducer. The one or more electrically-conductive contacts are configured for detachable electrical connection with corresponding contacts of the housing of the aerosol-generating device.

As used herein, the term “vibratable transducer” is used to refer to a device configured to convert energy from an initial form into a different form, where the different form comprises or consists of a vibratory output.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “aerosol-forming substrate” refers to a substrate consisting of or comprising an aerosol-forming material that is capable of releasing volatile compounds upon heating to generate an aerosol.

As used herein, the term “liquid” refers to a substance provided in liquid form and encompasses substances provided in the form of a gel.

The feature of the aerosolisation module being detachably insertable in a housing of an aerosol-generating device allows for the aerosolisation module to be removed from the housing of the device and replaced. So, in the event that, with use, the aerosolisation module became clogged with residue from the substrate or other debris, the aerosolisation module could be removed from the housing and replaced. In this manner, the aerosol-generating device may be reusable with other aerosolisation modules. The provision of the one or more electrically-conductive contacts being configured for detachable electrical connection with corresponding contacts of the housing of the device allows for an electrical signal to be conveyed from the housing to drive the transducer, with the detachable electrical connectability of the contacts facilitating easy removal and replacement of the aerosolisation module. The use of electrically-conductive contacts which are configured for detachable electrical connection with corresponding contacts of the housing of the device contrasts with known nebulizers which may use soldered wire connections intended to provide a permanent coupling between a power source of the nebuliser and the transducer.

At least one of the one or more electrically-conductive contacts may form part of the vibratable transducer. In this manner, an electrical signal may be conveyed directly to the transducer.

Preferably, the aerosolisation module may further comprise a membrane. The membrane may comprise an aerosol-generation zone. The vibratable transducer may be operably coupled to the membrane so as to, in use, vibrate the membrane. When employing the aerosolisation module as part of an aerosol-generating device, liquid aerosol-forming substrate fed to the aerosol-generation zone of the membrane may be aerosolised through vibration of the membrane. Advantageously, the aerosol-generation zone may be provided with a plurality of nozzles for the passage there-through of liquid aerosol-forming substrate. As used herein, the term “nozzle” is used to refer to an aperture, hole or bore through the membrane that provides a passage for liquid aerosol-forming substrate to move through the membrane. By way of example and without limitation, during use of the aerosol-generating device a liquid aerosol-forming substrate may be brought into contact with a first side of the membrane. Vibration of the membrane may result in a portion of the liquid substrate being urged and expelled through the nozzles so as to be emitted as a spray of aerosol droplets from a second opposing side of the membrane. The nozzles may be individually sized and arranged relative to each other so as to provide a predetermined aerosol droplet formation pattern.

Preferably, the nozzles are circular in shape. The use of nozzles which are circular in shape is preferred because the circular shape maximizes the ratio of area to perimeter of the respective nozzle, therefore reducing viscous drag forces and boundary layer build-up. However, the use of nozzles which are elliptical in shape has also been found to result in acceptable performance in terms of the resulting aerosol droplet formation.

The membrane may be formed of any suitable material. By way of example and without limitation, the membrane may be formed of a polymer material, thereby providing advantages of reduced mass and inertia. However, the membrane may be formed of any other suitable material, such as a metallic material. The membrane may be a composite of two or more different materials. The choice of material(s) used for the membrane may be influenced by the particular liquid aerosol-forming substrate(s) intended to be used with and aerosolised by the aerosolisation module. For example, it is highly desirable to choose a material for the membrane which does not chemically react with or degrade as a consequence of contact with the chosen liquid aerosol-forming substrate. By way of example only, the membrane may be formed of any of palladium, stainless steel, copper-nickel alloy, polyimide, polyamide, silicon or aluminium nitride.

Advantageously, the membrane may be circular in when viewed in plan. A circular membrane has been found beneficial when the aerosolisation module forms part of a handheld elongated aerosol-generating device intended to be used as a smoking device. However, the membrane may alternatively be rectangular in plan.

The membrane may be formed of an electrically-conductive material. A portion of the membrane may form at least one of the one or more electrically-conductive contacts. In this manner, the membrane may itself serve as a means of electrically coupling the vibratable transducer to the housing of the aerosol-generating article. The one or more electrically-conductive contacts may comprise a first electrically-conductive contact and a second electrically-conductive contact. A first portion of the membrane may form the first electrically conductive contact and a second portion of the membrane may form the second electrically-conductive contact.

The vibratable transducer may comprise at least one actuator. Preferably the actuator is a piezo-electric actuator. Piezo-electric actuators are preferred because they are an energy-efficient and light-weight means of providing a vibratory output from an electric input. Piezo-electric actuators possess a high energy conversion efficiency from electric to acoustic/mechanical power. Further, piezo-electric actuators are available in a wide variety of materials and shapes. For a piezo-electric actuator, inputting an electrical driving signal to the piezo-electric actuator would result in a mechanical output in the form of a vibration signal. Where the vibratable transducer of the aerosolisation module is operably coupled to a membrane as described above, the use of a piezo-electric actuator in or as the transducer provides an energy-efficient means of inducing vibration of the membrane so as to aerosolise the liquid aerosol-forming substrate. However, as an alternative to the use of piezo-electric actuators, actuator(s) including one or more of electromagnetic elements, magnetostrictive elements, or electrostrictive elements may also be employed in the vibratable transducer.

Where the vibratable transducer of the aerosolisation module is operably coupled to a membrane as described above, the vibratable transducer may comprise an annular actuator assembly coupled to a surface of the membrane to encircle the aerosol-generation zone. The annular actuator assembly may comprise one or more actuators. The annular actuator assembly may comprise a single annular actuator. Alternatively, the annular actuator assembly may comprise two or more actuators arranged circumferentially relative to each other to define an annulus encircling the aerosol-generation zone. As described in the preceding paragraph, the actuator(s) may take the form of one or more piezo-electric actuators. Alternatively, the actuator(s) may include one or more of electromagnetic elements, magnetostrictive elements, or electrostrictive elements.

In another example applicable to where the vibratable transducer of the aerosolisation module is operably coupled to a membrane, the vibratable transducer may comprise a pair of annular actuator assemblies provided as a first annular actuator assembly and a second annular actuator assembly. Each of the first and second annular actuator assemblies may comprise one or more actuators. Further, the first and second annular actuator assemblies may be arranged to couple to opposing surfaces of the membrane such that an annulus of the membrane is confined between the first and second annular actuator assemblies, the annulus encircling the aerosol-generation zone. The one or more electrically-conductive contacts comprise one or more first electrically-conductive contacts in electrical communication with the first annular actuator assembly and one or more second electrically-conductive contacts in electrical communication with the second annular actuator assembly. By confining opposing surfaces of the membrane between the first and second annular actuator assemblies, the membrane is able to be gripped between the actuator assemblies and vibratory output from the actuator assemblies thereby efficiently conveyed to the membrane to induce vibration of the membrane. Either or both of the first and second annular actuator assemblies may comprise a single annular actuator. Alternatively, either or both of the first and second actuator assemblies may comprise two or more actuators arranged circumferentially relative to each other to define an annulus. As described in the preceding paragraphs, the actuator(s) may take the form of one or more piezo-electric actuators. Alternatively, the actuator(s) may include one or more of electromagnetic elements, magnetostrictive elements, or electrostrictive elements.

Conveniently, both the first and second electrically conductive contacts may be arranged adjacent each other. Adjacent positioning of the first and second electrically conductive contacts helps to facilitate reliable electrical coupling of the contacts of the aerosolisation module with the corresponding contacts of the housing of the aerosol-generating device. Preferably, the first and second electrically-conductive contacts may be located on a common surface of the aerosolisation module. The provision of the first and second electrically conductive contacts on such a common surface again helps to facilitate reliable electrical coupling of the contacts of the aerosolisation module with the corresponding contacts of the housing of the aerosol-generating device. In a first example, the first and second electrically-conductive contacts may be located on a peripheral side surface of the aerosolisation module; in this scenario, the peripheral side surface forms the “common surface”. In a second example, the first and second electrically-conductive contacts may be located on an upper or lower surface of the aerosolisation module; in this scenario, the upper or lower surface forms the “common surface”. The upper or lower surface may be or include a surface of one or both of the vibratable transducer and the membrane. The terms “upper” and “lower” are used in a relative sense.

At least one of the one or more electrically-conductive contacts may comprise a planar contact area. The use of a planar contact area on the one or more electrically-conductive contacts facilitates a sliding fit between the planar contact area of the respective electrically-conductive contact and a corresponding contact of the housing of the aerosol-generating device. The facilitating of such a sliding fit is consistent with the characteristic of the aerosolisation module being detachably insertable in the housing of the aerosol-generating device. At least one of the one or more electrically-conductive contacts may form part of a resilient connector. The use of a resilient connector may facilitate a reliable electrical connection between the electrically-conductive contacts of the aerosolisation module and the corresponding contacts of the housing of the aerosol-generating device. Explaining further, the resilience of the connector may result in the respective electrically-conductive contact being urged against the corresponding contact of the housing.

In a second aspect of the present disclosure, there is provided an aerosol-generating system. The aerosol-generating system comprises an aerosolisation module as outlined in relation to the first aspect of the present disclosure. The aerosol-generating system further comprises an elongate housing, the elongate housing containing a power source and one or more electrically-conductive contacts corresponding to the one or more electrically-conductive contacts of the aerosolisation module. The elongate housing is configured to detachably receive the aerosolisation module so as to establish a detachable electrical connection between the corresponding electrically-conductive contacts of the housing and the aerosolisation module such that the elongate housing is electrically coupled to the vibratable transducer. Assembly of the aerosolisation module with the elongate housing forms an aerosol-generating device.

In this manner, the elongate housing is electrically coupled to the vibratable transducer of the aerosolisation module via the corresponding electrically-conductive contacts of the housing and the aerosolisation module. Accordingly, the power source may convey electrical power to the vibratable transducer of the aerosolisation module via the corresponding contacts.

Additionally, the aerosol-generating system may also comprise a controller couplable to the power supply and the vibratable transducer, the controller configured to generate a driving signal for the vibratable transducer. In one example, the controller may be contained in the elongate housing, in which case the driving signal generated by the controller may be communicated to the vibratable transducer via the corresponding electrically-conductive contacts of the housing and the aerosolisation module. Having both the power source and the controller within the elongate housing may help to reduce the complexity and cost of the aerosolisation module. In an alternative example, the controller may form part of the aerosolisation module. In this alternative scenario, the power source may supply power to the controller via the corresponding electrically-conductive contacts of the housing and the aerosolisation module, thereby enabling the controller (being part of the aerosolisation module) to generate and communicate the driving signal to the vibratable transducer. Having the controller being part of the aerosolisation module may also allow the use of different aerosolisation modules each configured to generate a distinct aerosol emission pattern, depending on the configuration of the controller of the respective aerosolisation module. The term “controller” encompasses control electronics and processor(s) configured for use in generating the driving signal for the vibratable transducer, as well as any computer-readable medium storing instructions for use in the generating of the driving signal. By way of example, the controller may take the form of control electronics and a non-transitory computer readable medium (such as a computer memory module), in which the control electronics comprise a control unit coupled to or containing the non-transitory computer readable medium. The control unit may itself contain or be coupled to a computer processor. The non-transitory computer readable medium may contain instructions for use in the generating of the driving signal.

Preferably, the power source is rechargeable. By way of example, the power source may comprise a lithium ion battery.

In this second aspect, the aerosolisation module forms a replaceable component of the aerosol-generating system. The ability to remove and replace the aerosolisation module from the elongate housing derives from there being a detachable electrical connection between the corresponding electrically-conductive contacts of the aerosolisation module and the elongate housing.

Preferably, the aerosol-generating system forms a smoking system configured for non-thermally generating an inhalable aerosol. As no heat is used in the non-thermal generation of aerosol, there is a reduced likelihood of producing harmful compounds, as these are usually associated with chemical reactions occurring at higher temperatures. Alternatively however, the aerosol-generating system may also comprise a heater element configured to apply heat to the liquid aerosol-forming substrate. Such a heater element may conveniently form part of the aerosolisation module.

The elongate housing may be sized and shaped to enable the housing to be hand-held by a user. The use of an elongate housing corresponds to the geometric profile associated with conventional cigarettes and various electronic cigarettes.

The housing may have a first housing part and a second housing part, with the first housing part containing the power source and the second housing part comprising a mouthpiece. Corresponding axial mating ends of the first housing part and the second housing part may be configured to couple to each other. The axial mating end of either the first housing part or the second housing part may comprise a seat for receiving the aerosolisation module. The coupling together of the corresponding axial mating ends of the first and second housing parts may facilitate secure coupling of the aerosolisation module with the housing. In use, a user may engage their mouth with the mouthpiece and thereby inhale aerosol droplets emanating from the aerosolisation module. In one example, the first and second housing parts may be hingeably connected to each other. Alternatively or in addition, each of the first and second housing parts may comprise a magnetic attraction member such that the corresponding axial mating ends of the first and second housing parts are magnetically attracted to each other to thereby securely couple the aerosolisation module with the housing. By “magnetic attraction member” is meant a member which generates a magnetic field (i.e. a magnet) or is magnetically attracted to a magnetic field. Preferably, the magnetic attraction member of at least one of the first and second housing parts is a magnet. Conveniently, the magnetic attraction members of the first housing part and the second housing part are magnets of opposite polarity.

At least one of the electrically-conductive contacts of the housing may be located in the seat. In this manner, correctly positioning the aerosolisation module within the seat would result in electrical connection between corresponding electrically-conductive contacts of the aerosolisation module and the elongate housing. The seat and the aerosolisation module may be keyed to each other such that the aerosolisation module is receivable in the seat in a predetermined orientation. The keying of the seat and the aerosolisation module to each other may provide additional assurance that the module can be received in the seat of the housing such that the corresponding electrical contacts of the module and housing are electrically-connected to each other.

A sidewall of the elongate housing may comprise an aperture, the aperture defining an access opening to a cavity extending within the housing. The one or more electrically-conductive contacts of the housing may be located in the cavity. The corresponding electrically-conductive contacts of the housing and the aerosolisation module may also be configured such that insertion of the aerosolisation module into the cavity results in electrical connection between the corresponding contacts of the housing and the aerosolisation module. The provision of such an aperture in the sidewall of the housing facilitates the aerosolisation module being slidably inserted into (or removed from) the elongate housing. The system may further comprise a cradle configured to receive the aerosolisation module, the cradle removably insertable into the cavity via the access opening. The cradle would function as a holder for the aerosolisation module. The cradle and the aerosolisation module may be keyed to each other such that the aerosolisation module is receivable in the cradle in a predetermined orientation. The keying of the cradle and the aerosolisation module to each other may provide additional assurance that the module is received in the cradle in such a position that on insertion of the cradle into the cavity, electrical connection between the corresponding contacts of the aerosolisation module and the elongate housing is assured. The cradle may be slidably coupled to the elongate housing. Additionally, either or both of the cradle and the housing may be configured to prevent uncoupling of the cradle from the housing. In one example, one of the cradle or the housing may include one or more lugs adapted to engage with corresponding parts of the other of the cradle or the housing to prevent complete uncoupling of the cradle from the housing. Preferably, the cradle may be profiled to define a substantially flush fit with the sidewall of the elongate housing after insertion of the cradle into the cavity. The provision of a substantially flush fit of the cradle with the sidewall of the elongate housing may ensure that the user is able to hold the elongate housing without discomfort.

The aerosol-generating system may further comprise a reservoir of liquid aerosol-forming substrate. The reservoir of liquid aerosol-forming substrate may form part of the aerosolisation module, the reservoir being in fluid communication with the vibratable transducer. In this manner, removal and replacement of the aerosolisation module would result in the system being provided with both a new vibratable transducer and a new reservoir of liquid aerosol-forming substrate. Alternatively, the reservoir of liquid aerosol-forming substrate may be provided as a cartridge distinct from the aerosolisation module, the cartridge detachably insertable in the housing such that the reservoir is in fluid communication with the vibratable transducer after the cartridge is inserted in the housing and the aerosolisation module received in the housing. The provision of such a cartridge which is detachably insertable into the housing and distinct from the aerosolisation module allows the reservoir of liquid aerosol-forming substrate to be renewed separately to the aerosolisation module.

The liquid aerosol-forming substrate employed may take many different forms. The following paragraphs describe various exemplary but non-limiting materials and compositions for the liquid aerosol-forming substrate.

The liquid aerosol-forming substrate may comprise nicotine. The nicotine-containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise at least one aerosol-former. An aerosol-former is any suitable known compound or mixture of compounds that, in use, facilitates formation of a dense and stable aerosol. Suitable aerosol-formers are well known in the art and include, but are not limited to: polyhydric alcohols, such as triethylene glycol, 1,3-butanediol and glycerine; esters of polyhydric alcohols, such as glycerol mono-, di-, or triacetate; and aliphatic esters of mono-, di-, or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The liquid aerosol-forming substrate may comprise other additives and ingredients, such as flavourants.

The liquid aerosol-forming substrate may comprise water.

The liquid aerosol-forming substrate may comprise nicotine and at least one aerosol former. The aerosol former may comprise glycerine. The aerosol-former may comprise propylene glycol. The aerosol former may comprise both glycerine and propylene glycol. The liquid aerosol-forming substrate may have a nicotine concentration of between about 2% and about 10%.

Preferably, the corresponding contacts of the elongate housing and the aerosolisation module may be configured to define a slidable interface between the corresponding contacts.

The provision of such a slidable interface is consistent with the characteristic of the aerosolisation module being detachably insertable in the elongate housing of the aerosol-generating device. By way of example, the electrically-conductive contacts of either the elongate housing or the aerosolisation module may comprise a planar contact area, as described above in relation to the first aspect of the present disclosure.

Conveniently, at least one of the one or more electrically-conductive contacts of one of the elongate housing or the aerosolisation module forms part of a resilient connector. The resilient connector may be configured to elastically deform on contact with the corresponding contact of the other of the elongate housing or the aerosolisation module. As described above in relation to the first aspect, the use of a resilient connector may facilitate a reliable electrical connection between the corresponding electrically-conductive contacts of the aerosolisation module and the elongate housing.

In a third aspect of the present disclosure, there is provided a kit of parts, the parts when assembled forming an aerosol-generating device. The parts comprise a first aerosolisation module and a second aerosolisation module, each of the first and second aerosolisation modules being according to the first aspect of the present disclosure described above. The parts further comprise an elongate housing. The elongate housing contains a power source and one or more electrically-conductive contacts corresponding to the one or more electrically-conductive contacts of the aerosolisation module. The elongate housing is configured to detachably receive one of the first and the second aerosolisation modules so as to establish a detachable electrical connection between the corresponding electrically-conductive contacts of the housing and the respective aerosolisation module such that the elongate housing is electrically coupled to the vibratable transducer. The first and second aerosolisation modules are interchangeable with each other in the elongate housing so as to be detachably received in the elongate housing. The first aerosolisation module is configured to generate a first aerosol emission pattern and the second aerosolisation module is configured to generate a second aerosol emission pattern, the first and second aerosol emission patterns being distinct from each other. The provision of such a kit allows a user to swap between the first and second aerosolisation modules according to the user's preferred aerosol emission pattern. The first and second aerosol emission patterns may differ in one or more of the following characteristics: aerosol droplet size and density of aerosol droplets (i.e. the number of aerosol droplets per unit volume).

In other example, the kit may include additional aerosolisation modules having an aerosol emission pattern different from either of the first and second aerosolisation modules. In this way, the user may be provided with additional flexibility to experience different aerosol emission patterns.

The invention is defined in the claims. However, below there is provided a non-exhaustive list of non-limiting examples. Any one or more of the features of these examples may be combined with any one or more features of another example, embodiment, or aspect described herein.

Example Ex1: An aerosolisation module detachably insertable in a housing of an aerosol-generating device, the aerosolisation module comprising: a vibratable transducer for aerosolising a liquid aerosol-forming substrate; one or more electrically-conductive contacts in electrical communication with the vibratable transducer; in which the one or more electrically-conductive contacts are configured for detachable electrical connection with corresponding contacts of the housing of the aerosol-generating device.

Example Ex2: An aerosolisation module according to Ex1, in which at least one of the one or more electrically-conductive contacts forms part of the vibratable transducer.

Example Ex3: An aerosolisation module according to either of Ex1 or Ex2, in which the aerosolisation module further comprises a membrane, the membrane comprising an aerosol-generation zone, the vibratable transducer operably coupled to the membrane so as to, in use, vibrate the membrane.

Example Ex4: An aerosolisation module according to Ex3, in which the aerosol-generation zone is provided with a plurality of nozzles for the passage there-through of liquid aerosol-forming substrate.

Example Ex5: An aerosolisation module according to either of Ex3 or Ex4, in which the membrane is formed of an electrically-conductive material, and a portion of the membrane forms at least one of the one or more electrically-conductive contacts.

Example Ex6: An aerosolisation module according to Ex5, in which the one or more electrically-conductive contacts comprise a first electrically-conductive contact and a second electrically-conductive contact, in which a first portion of the membrane forms the first electrically conductive contact and a second portion of the membrane forms the second electrically-conductive contact.

Example Ex7: An aerosolisation module according to any one of Ex1 to Ex6, in which the vibratable transducer comprises at least one actuator.

Example Ex8: An aerosolisation module according to any one of Ex3 to Ex6, in which the vibratable transducer comprises an annular actuator assembly coupled to a surface of the membrane to encircle the aerosol-generation zone, the annular actuator assembly comprising one or more actuators.

Example Ex9: An aerosolisation module according to Ex8, in which the annular actuator assembly comprises a single annular actuator.

Example Ex10: An aerosolisation module according to Ex8, in which the annular actuator assembly comprises two or more actuators arranged circumferentially relative to each other to define an annulus encircling the aerosol-generation zone.

Example Ex11: An aerosolisation module according to any one of Ex3 to Ex10, in which the vibratable transducer comprises a pair of annular actuator assemblies provided as a first annular actuator assembly and a second annular actuator assembly, each of the first and second annular actuator assemblies comprising one or more actuators, the first and second annular actuator assemblies arranged to couple to opposing surfaces of the membrane such that an annulus of the membrane is confined between the first and second annular actuator assemblies, the annulus encircling the aerosol-generation zone, wherein the one or more electrically-conductive contacts comprise one or more first electrically-conductive contacts in electrical communication with the first annular actuator assembly and one or more second electrically-conductive contacts in electrical communication with the second annular actuator assembly.

Example Ex12: An aerosolisation module according to Ex11, in which either or both of the first and second annular actuator assemblies comprises a single annular actuator.

Example Ex13: An aerosolisation module according to Ex11, in which either or both of the first and second annular piezo-electric assemblies comprise two or more piezo-electric actuators arranged circumferentially relative to each other to define an annulus.

Example Ex14: An aerosolisation module according to any one of Ex11 to Ex13, in which the first and second electrically-conductive contacts are arranged adjacent each other.

Example Ex15: An aerosolisation module according to any one of Ex11 to Ex14, in which the first and second electrically-conductive contacts are located on a common surface of the aerosolisation module.

Example Ex16: An aerosolisation module according to Ex15, in which the first and second electrically-conductive contacts are located on a peripheral side surface of the aerosolisation module.

Example Ex17: An aerosolisation module according to Ex15, in which the first and second electrically-conductive contacts are located on an upper or lower surface of the aerosolisation module.

Example Ex18: An aerosolisation module according to any one of Ex1 to Ex17, in which at least one of the one or more electrically-conductive contacts comprises a planar contact area.

Example Ex19: An aerosolisation module according to any one of Ex1 to Ex18, in which at least one of the one or more electrically-conductive contacts forms part of a resilient connector.

Example Ex20: An aerosol-generating system comprising: an aerosolisation module according to any one of Ex1 to Ex19; an elongate housing, the elongate housing containing a power source and one or more electrically-conductive contacts corresponding to the one or more electrically-conductive contacts of the aerosolisation module; the elongate housing configured to detachably receive the aerosolisation module so as to establish a detachable electrical connection between the corresponding electrically-conductive contacts of the housing and the aerosolisation module such that the elongate housing is electrically coupled to the vibratable transducer; wherein assembly of the aerosolisation module with the elongate housing forms an aerosol-generating device.

Example Ex20a: An aerosol-generating device comprising: an aerosolisation module according to any one of Ex1 to Ex19; an elongate housing, the elongate housing containing a power source and one or more electrically-conductive contacts corresponding to the one or more electrically-conductive contacts of the aerosolisation module; the elongate housing configured to detachably receive the aerosolisation module so as to establish a detachable electrical connection between the corresponding electrically-conductive contacts of the housing and the aerosolisation module such that the elongate housing is electrically coupled to the vibratable transducer.

Example Ex21: An aerosol-generating system or device according to Ex20 or Ex20a, the system or device further comprising a controller couplable to the power supply and the vibratable transducer, the controller configured to generate a driving signal for the vibratable transducer.

Example Ex22: An aerosol-generating system or device according to Ex21, in which the elongate housing contains the controller; wherein, in use of the aerosol-generating device, the driving signal generated by the controller is communicated to the vibratable transducer via the corresponding electrically-conductive contacts of the housing and the aerosolisation module.

Example Ex23: An aerosol-generating system or device according to Ex21, in which the aerosolisation module comprises the controller; wherein, in use of the aerosol-generating device, the power source supplies power to the controller via the corresponding electrically-conductive contacts of the housing and the aerosolisation module.

Example Ex24: An aerosol-generating system or device according to any one of Ex20 to Ex23, in which the housing has a first housing part and a second housing part, the first housing part containing the power source, the second housing part comprising a mouthpiece, wherein corresponding axial mating ends of the first housing part and the second housing part are configured to couple to each other, wherein the axial mating end of either the first housing part or the second housing part comprises a seat for receiving the aerosolisation module.

Example Ex25: An aerosol-generating system or device according to Ex24, in which the first and second housing parts are hingeably connected to each other.

Example Ex26: An aerosol-generating system or device according to either of Ex24 or Ex25, in which each of the first and second housing parts comprise a magnetic attraction member such that the corresponding axial mating ends of the first and second housing parts are magnetically attracted to each other to thereby securely couple the aerosolisation module with the housing.

Example Ex27: An aerosol-generating system or device according to any one of Ex24 to Ex26, in which at least one of the one or more electrically-conductive contacts of the housing are located in the seat.

Example Ex28: An aerosol-generating system or device according to any one of Ex24 to Ex27, in which the seat and the aerosolisation module are keyed to each other such that the aerosolisation module is receivable in the seat in a predetermined orientation.

Example Ex29: An aerosol-generating system or device according to any one of Ex20 to Ex23, in which a sidewall of the elongate housing comprises an aperture, the aperture defining an access opening to a cavity extending within the housing, the one or more electrically-conductive contacts of the housing located in the cavity, wherein the corresponding electrically-conductive contacts of the housing and the aerosolisation module are configured such that insertion of the aerosolisation module into the cavity results in electrical connection between the corresponding contacts of the housing and the aerosolisation module.

Example Ex30: An aerosol-generating system or device according to Ex29, further comprising a cradle configured to receive the aerosolisation module, the cradle removably insertable into the cavity via the access opening.

Example Ex31: An aerosol-generating system or device according to Ex30, in which the cradle and the aerosolisation module are keyed to each other such that the aerosolisation module is receivable in the cradle in a predetermined orientation.

Example Ex32: An aerosol-generating system or device according to either of Ex30 or Ex31, in which the cradle is slidably coupled to the elongate housing.

Example Ex33: An aerosol-generating system or device according to any one of Ex30 to Ex32, in which either or both of the cradle and the housing are configured to prevent uncoupling of the cradle from the housing.

Example Ex34: An aerosol-generating system or device according to any one of Ex30 to Ex33, in which the cradle is profiled to define a substantially flush fit with the sidewall of the elongate housing after insertion of the cradle into the cavity.

Example Ex35: An aerosol-generating system or device according to any one of Ex20 to Ex34, further comprising a reservoir of liquid aerosol-forming substrate.

Example Ex36: An aerosol-generating system or device according to Ex35, in which the reservoir of liquid aerosol-forming substrate forms part of the aerosolisation module, the reservoir being in fluid communication with the vibratable transducer.

Example Ex37: An aerosol-generating system or device according to Ex35, in which the reservoir of liquid aerosol-forming substrate is provided as a cartridge distinct from the aerosolisation module, the cartridge detachably insertable in the housing such that the reservoir is in fluid communication with the vibratable transducer after the cartridge is inserted in the housing and the aerosolisation module assembled with the housing.

Example Ex38: An aerosol-generating system or device according to any one of Ex20 to Ex37, in which the corresponding contacts of the elongate housing and the aerosolisation module are configured to define a slidable interface between the corresponding contacts.

Example Ex39: An aerosol-generating system or device according to any one of Ex20 to Ex38, in which at least one of the one or more electrically-conductive contacts of one of the elongate housing or the aerosolisation module forms part of a resilient connector, the resilient connector configured to elastically deform on contact with the corresponding contact of the other of the elongate housing or the aerosolisation module.

Example Ex40: A kit of parts, the parts when assembled forming an aerosol-generating device, the parts comprising: a first aerosolisation module; a second aerosolisation module; each of the first and second aerosolisation modules being according to any one of Ex1 to Ex19; an elongate housing, the elongate housing containing a power source and one or more electrically-conductive contacts corresponding to the one or more electrically-conductive contacts of the aerosolisation module; the elongate housing configured to detachably receive one of the first and the second aerosolisation modules so as to establish a detachable electrical connection between the corresponding electrically-conductive contacts of the housing and the respective aerosolisation module such that the elongate housing is electrically coupled to the vibratable transducer; in which the first and second aerosolisation modules are interchangeable with each other in the elongate housing so as to be detachably received in the elongate housing, wherein the first aerosolisation module is configured to generate a first aerosol emission pattern and the second aerosolisation module is configured to generate a second aerosol emission pattern, the first and second aerosol emission patterns being distinct from each other.

Examples will now be further described with reference to the figures, in which:

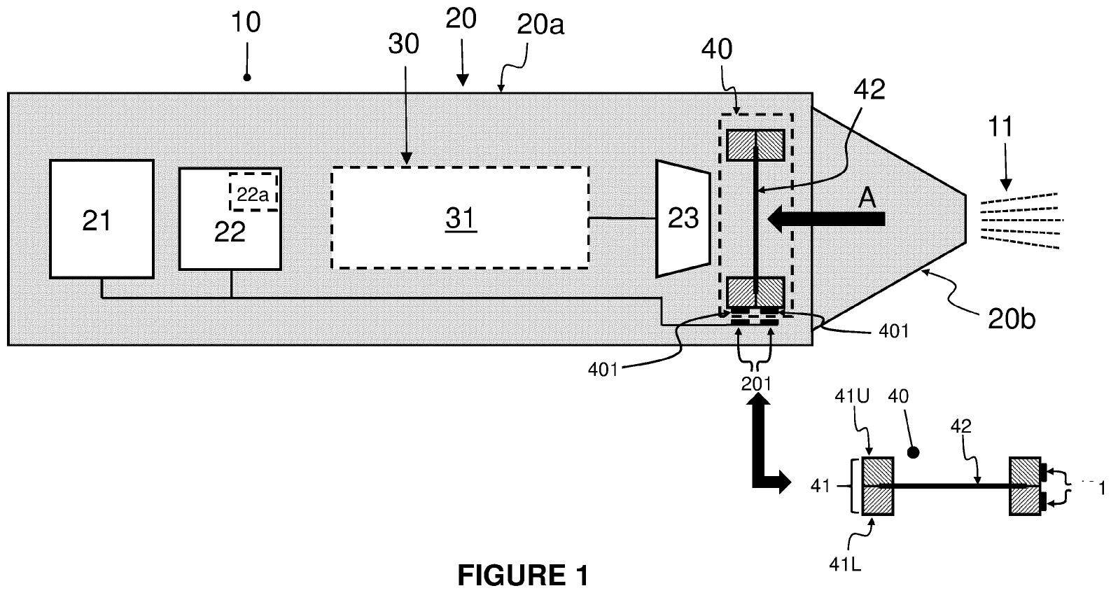

FIG. 1 is a schematic view of a first example of an aerosol-generating system.

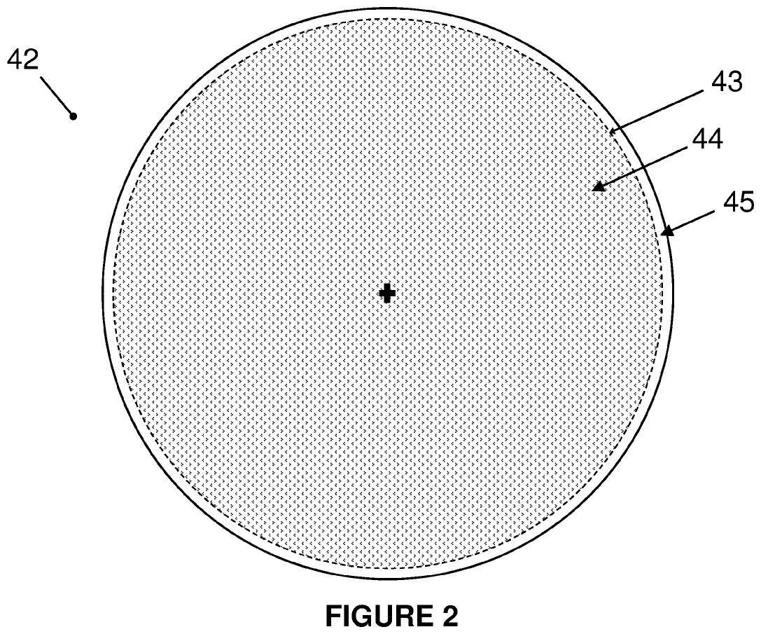

FIG. 2 is a plan view of a membrane of an aerosolisation module used in the aerosol-generating system of FIG. 1.

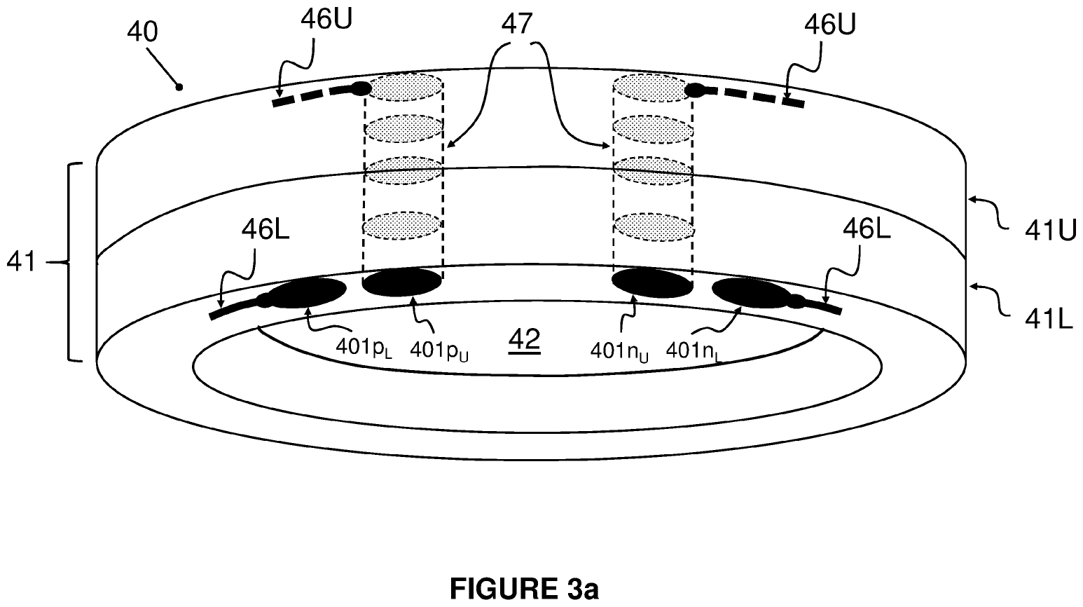

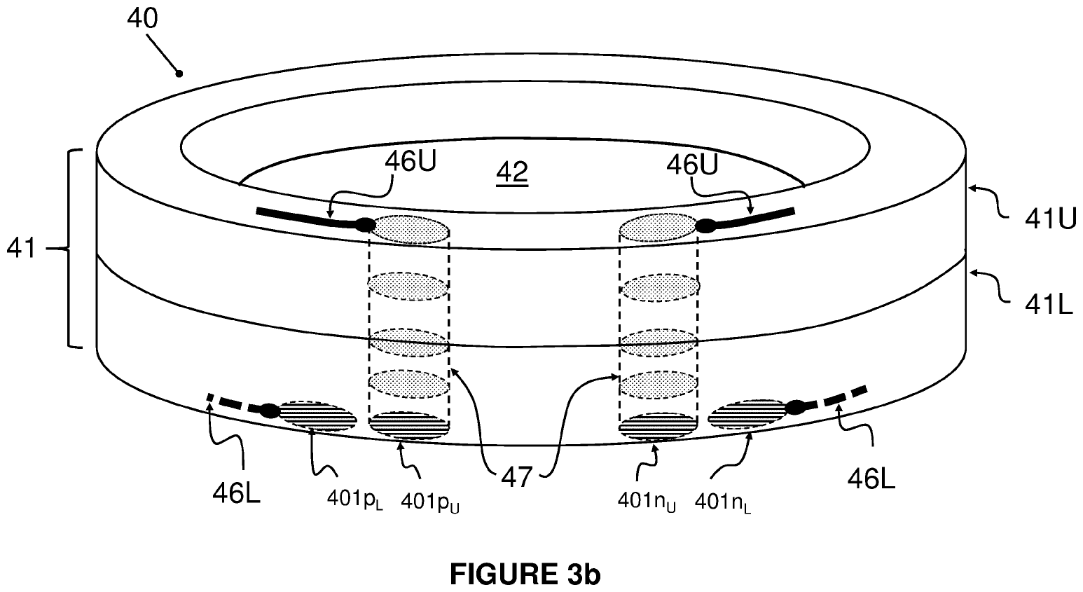

FIG. 3a is a perspective view of the underside of a first example of an aerosolisation module suitable for use in the aerosol-generating system of FIG. 1.

FIG. 3b is a perspective view from above of the aerosolisation module of FIG. 3a.

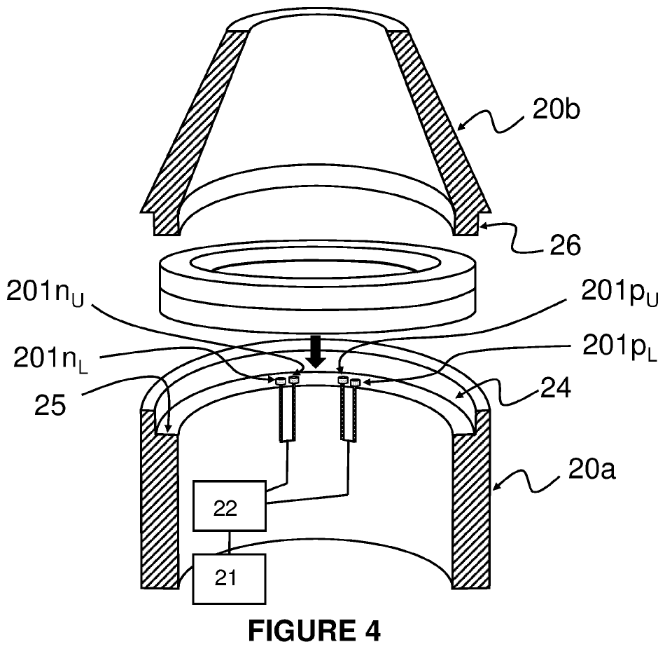

FIG. 4 is an exploded view of an upper portion of an aerosol-generating device incorporating the aerosolisation module of FIGS. 3a,b, with the module positioned between a cylindrical wall and mouthpiece of a housing of the device. This figure illustrates the detachable electrical connection between electrically-conductive contacts of the housing and the aerosolisation module.

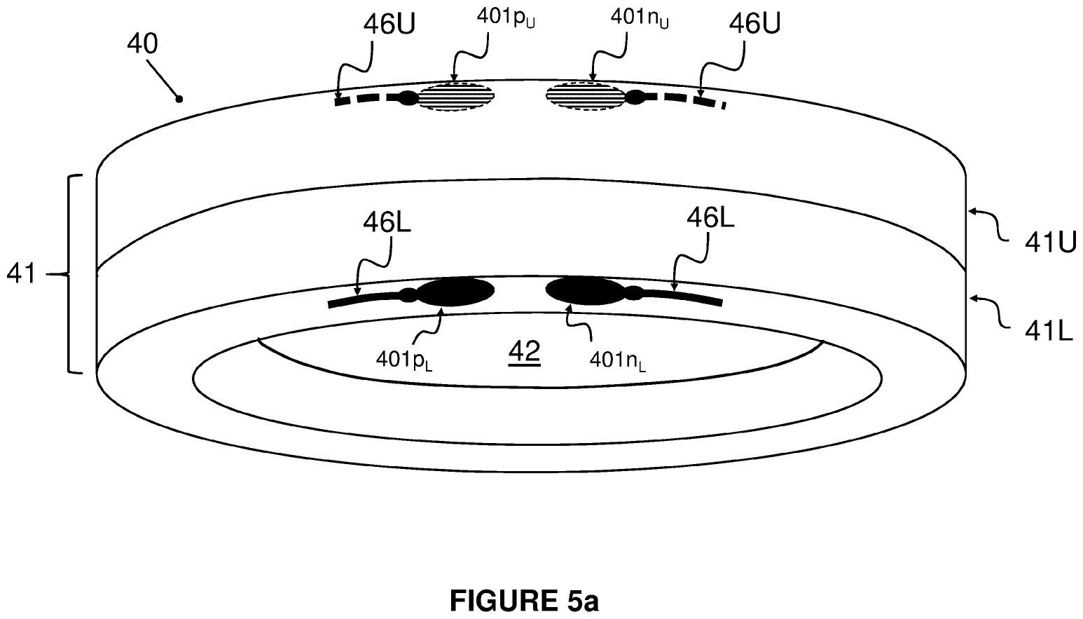

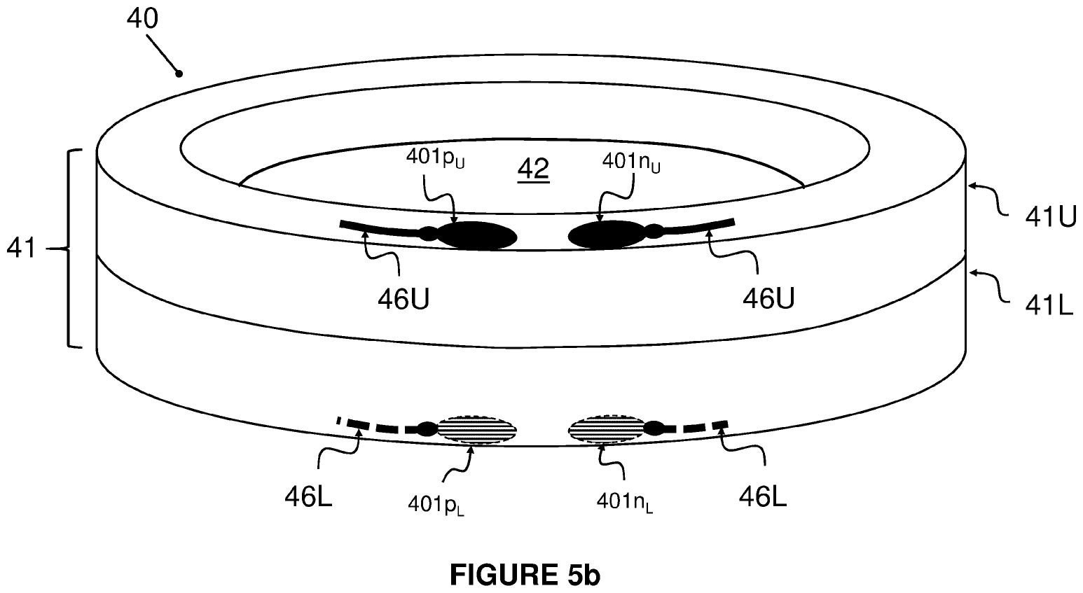

FIG. 5a is a perspective view of the underside of a second example of an aerosolisation module suitable for use in the aerosol-generating system of FIG. 1.

FIG. 5b is a perspective view from above of the aerosolisation module of FIG. 5a.

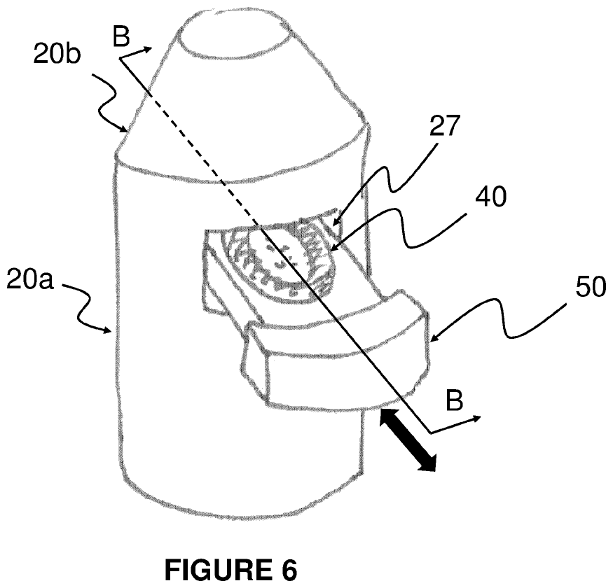

FIG. 6 is a perspective view of an aerosol-generating device including a slidable cradle for receiving the aerosolisation module of FIGS. 5a,b.

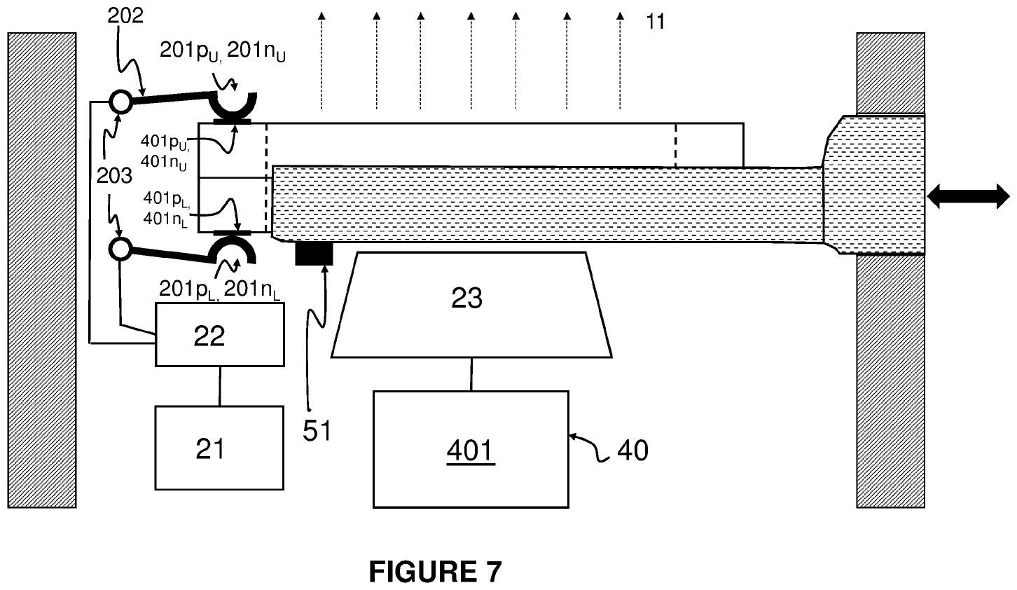

FIG. 7 is a cross-section view of the aerosol-generating device of FIG. 6 illustrating the detachable electrical connection between the electrically-conductive contacts of a housing of the device and the aerosolisation module when the cradle is inserted inside the housing of the device.

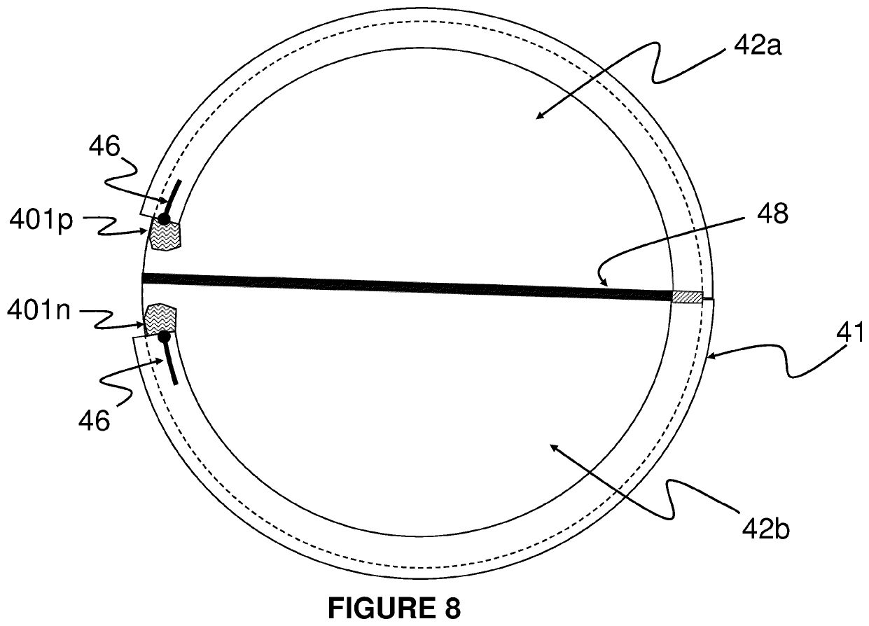

FIG. 8 is a plan view of a third example of an aerosolisation module.

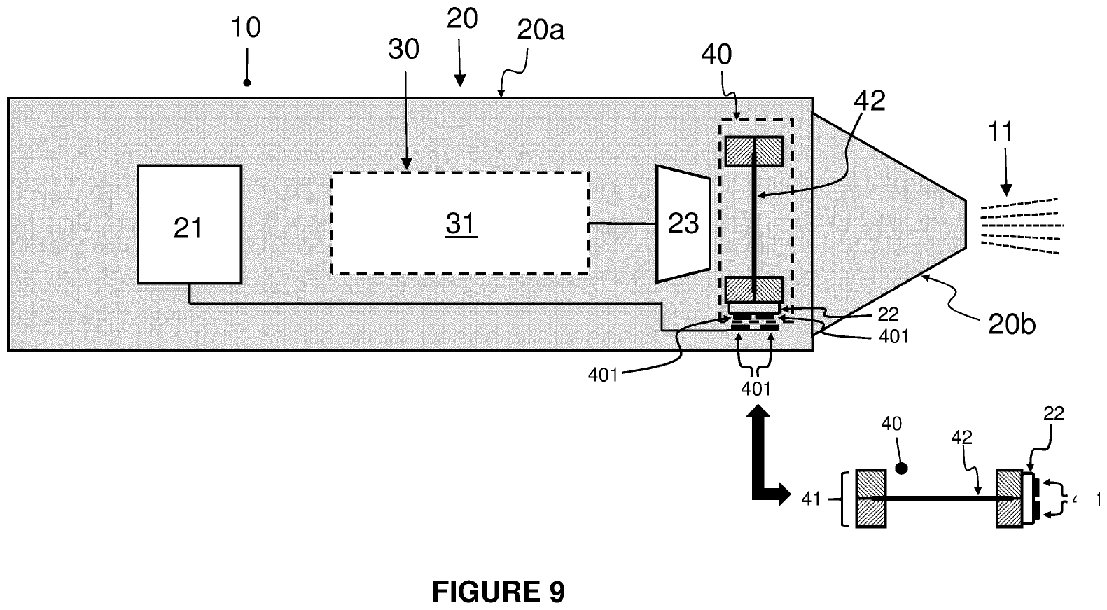

FIG. 9 is a schematic view of a second example of an aerosol-generating system.

FIG. 1 is a schematic view of a first example of an aerosol-generating system 10. The aerosol-generating system 10 is a smoking system for generating an inhalable aerosol 11. The system 10 has an elongate housing 20, a cartridge 30 and an aerosolisation module 40. For the example shown and described, the elongate housing 20 is generally cylindrical and is formed of a polymer material. The cartridge 30 is detachably receivable within the elongate housing 20, as will be described in more detail in the following paragraphs. Similarly, for the example shown in FIG. 1, the aerosolisation module 40 is also detachably receivable within the housing 20. The cartridge 30 and aerosolisation module 40 are replaceable components of the aerosol-generating system 10. Consequently, the elongate housing 20 is reusable with different aerosolisation modules 30 and cartridges 40. When the cartridge 30 and aerosolisation module 40 are assembled within the elongate housing 20, the combination of the housing, cartridge and aerosolisation module collectively forms an aerosol-generating device.

The elongate housing 20 contains a power source 21, a controller 22 and a liquid feed assembly 23. The elongate housing 20 has a cylindrical portion 20a and a mouthpiece portion 20b. The mouthpiece portion 20b is fitted to one end of the cylindrical portion 20a to form a mouth end of the elongate housing 20. The power source 21 is coupled to the controller 22 to provide power thereto. For the example shown, the power source 21 is a rechargeable battery, which serves as a source of electrical power. For the example shown and described, the controller 22 takes the form of control electronics. The controller 22 also incorporates a memory module 22a containing instructions accessible by a processor (not shown) of the controller so as to control operation of the aerosolisation module 40. The controller 22 is configured to generate an electrical driving signal which is conveyed, along wiring or similar electrically-conductive members, to electrically-conductive contacts 201 within the housing 20. The electrically-conductive contacts 201 of the housing 20 detachably interface with corresponding electrically-conductive contacts 401 of the aerosolisation module 40. The nature of various exemplary interfaces between the corresponding electrically-conductive contacts 201, 401 of the housing 20 and the aerosolisation module 40 is described in the following paragraphs.

The cartridge 30 contains a reservoir 31 of liquid aerosol-forming substrate. The liquid aerosol-forming substrate contains nicotine. When the cartridge 30 is received in the elongate housing 20, the cartridge is fluidically coupled to the liquid feed assembly 23. The liquid feed assembly 23 has the form of a wicking material extending between the cartridge 30 and the aerosolisation module 40 so as to progressively feed liquid aerosol-forming substrate from the reservoir 31 to the aerosolisation module. In an alternative example (not shown), the liquid feed assembly 23 is a pump powered by the power source 21. In a further alternative example (not shown), the liquid feed assembly 23 forms part of the cartridge 30.

The aerosolisation module 40 has a vibratable transducer 41 and a membrane 42. The vibratable transducer 41 has a pair of annular piezo-electric actuator assemblies 41U, 41L. The annular actuator assemblies 41U, 41L are coupled to opposing surfaces of the membrane 42 to secure an annulus of the membrane there between. Each annular actuator assembly 41U, 41L is formed of a single ring-shaped single piezo-actuator. In an alternative example (not shown), each annular actuator assembly 41U, 41L is instead formed of two or more piezo-actuators coupled together and arranged circumferentially to collectively define a ring-shaped form. In a further alternative example (not shown), the vibratable transducer 41 has a single piezo-electric actuator assembly; for example, one of assembly 41U, 41L.

When the aerosolisation module 40 is received in the elongate housing 20, the electrically-conductive contacts 201 of the housing 20 are in contact and electrical communication with the electrically-conductive contacts 401 of the aerosolisation module 40. As illustrated schematically in FIG. 1 and as is clear from the preceding paragraphs, electrical contact between the corresponding contacts 201, 401 of the housing 20 and the aerosolisation module 40 is non-permanent so that the aerosolisation module may be removed from the housing. This allows the aerosolisation module 40 to be re-inserted or swapped with a replacement aerosolisation module (as indicated by the double-headed arrow in FIG. 1). Although not shown in the figures, the replacement aerosolisation module may be adapted to generate an aerosol emission pattern which is different to that generated by the original aerosolisation module.

FIG. 2 shows a plan view of the membrane 42 of the aerosolisation module 40, i.e. when viewed in the direction of arrow A of FIG. 1. For convenience, the pair of annular actuator assemblies 41U, 41L are excluded from FIG. 2. In the example shown and described, the membrane 42 is formed of a polymer material. However, as described above, other materials may be selected for the membrane 42, with the membrane material being one which has minimal to zero chemical reactivity with the composition of the liquid aerosol-forming substrate. The membrane 42 is circular in plan view to correspond with the annular nature of the actuator assemblies 41U, 41L. However, in alternative examples (not shown) the membrane 42 may be any other shape when viewed in plan, such as rectangular. The membrane 42 has an aerosol-generation zone 43 (the periphery of which is represented by a broken line in FIG. 2). The aerosol generation zone 43 is provided with a plurality of nozzles 44 (represented by a pattern of dots in FIG. 2). The nozzles 44 are in the form of holes extending through the thickness of the membrane 42. An annular gap 45 is present between the periphery of the membrane 42 and the periphery of the aerosol generation zone 43. The annular gap 45 provides space to enable the upper and lower annular actuator assemblies 41U, 41L to press against opposing surfaces of the membrane 42. The terms “upper” and “lower” are used only in a relative sense so as to describe the location of the actuator assemblies 41U, 41L relative to each other and the membrane 42.

FIGS. 3a and 3b show perspective views of a first example of the aerosolisation module 40. FIG. 4 illustrates how the aerosolisation module 40 of FIGS. 3a,b is positioned between cylindrical portion 20a and mouthpiece portion 20b of the elongate housing 20 so as to provide a detachable electrical connection between the housing 20 and the aerosolisation module 40.

The electrically-conductive contacts 401 of the aerosolisation module 40 of FIGS. 3a,b are formed of electrically-conductive plates 401p_{L}, 401pu, 401n_{L}, 401nu defined on the lowermost surface of the lower actuator assembly 41L. Plates 401p L and 401n L are connected to electrodes 46L of the lower actuator assembly 41L. Plates 401p_{L}, 401n L and electrodes 46L serve to deliver the electrical driving signal generated by the controller 22 to the lower actuator assembly 41L of the vibratable transducer 41. Plates 401pu, 401nu each connect to a metallic core 47. Each metallic core 47 vertically extends from its respective plate 401pu, 401nu along the height of the aerosolisation module 40 to connect with electrodes 46U of the upper actuator assembly 41U. The plates 401pu, 401nu, their corresponding metallic cores 47 and electrodes 46U serve to deliver the electrical driving signal generated by the controller 22 to the upper actuator assembly 41U of the vibratable transducer 41. For the example of FIGS. 3a,b, the electrically-conductive plates 401p_{L}, 401pu, 401n_{L}, 401nu are all provided on a common face of the aerosolisation module 40, namely the lowermost surface of the aerosolisation module. For the example shown, the plates 401p_{L}, 401pu, 401n_{L}, 401nu are formed of metal.

As shown in FIG. 4, a recessed annular seat 24 is defined at one end of the cylindrical portion 20a of the elongate housing 20. The electrically-conductive contacts 201 have the form of electrically-conductive spring-loaded pin connectors 201p_{L}, 201pu, 201 nL, 201nu which protrude from the base 25 of the seat 24. Pin connectors 201p L and 201n L are associated with the electrical driving signal for the lower actuator assembly 41L. Pin connectors 201pu and 201nu are associated with the electrical driving signal for the upper actuator assembly 41U. In use, the aerosolisation module 40 would be placed in the seat 24 so that the lowermost surface of the aerosolisation module rests on the base 25 of the seat. VVhen the aerosolisation module 40 is positioned in the seat 24, the pin connectors 201p_{L}, 201n L press against the corresponding surfaces of plates 401p_{L}, 401n_{L}, and pin connectors 201pu, 201nu press against the corresponding surfaces of plates 401pu, 401nu. One end of the mouthpiece portion 20b of the housing 20 is formed with an annular step 26 corresponding to the annular seat 24. The mouthpiece portion 20b is mated with the cylindrical portion 20a so that the annular step 26 locates in the seat 24 and presses down on the uppermost surface of the aerosolisation module 40. Mechanical means (not shown) are provided to secure the cylindrical portion 20a and mouthpiece portion 20b together. By way of example (not shown), corresponding faces of the cylindrical portion 20a and mouthpiece portion 2b may be correspondingly threaded to define a screw fit, or alternatively may be profiled to define a bayonet fit between the two portions 20a,b. In a further alternative (not shown), the corresponding faces of the cylindrical portion 20a and mouthpiece portion 20b may include respective magnets of opposite polarity such that the portions 20a, 20b are magnetically attracted to each other.

When the mouthpiece portion 20b is secured to the cylindrical portion 20a, the lowermost surface of the aerosolisation module 40 would be firmly pressed against the base 25 of the seat 24 to depress pin connectors 201p_{L}, 201pu, 201n_{L}, 201nu into recesses (not shown) provided in the base 25. The spring-loaded nature of the connectors 201p_{L}, 201pu, 201n_{L}, 201nu helps to urge the connectors against the surface of the corresponding plates 401p_{L}, 401pu, 401 nL, 401nu of the aerosolisation module 40. In an alternative example (not shown), the aerosolisation module 40 and the seat 24 are provided with indexing features to provide a predetermined alignment between the aerosolisation module 40 and the seat 24. Such indexing features may help to ensure that the connectors 201p_{L}, 201pu, 201n_{L}, 201nu electrically interface with their corresponding plates 401p_{L}, 401pᵤ, 401n_{L}, 401nᵤ. Examples of suitable indexing features include mating lugs and recesses on the aerosolisation module 40 and the seat 24.

In use, the controller 22 accesses the memory module 22a and generates the electrical driving signal which is conveyed along the internal wiring or similar to the electrically-conductive contacts 201 of the housing 20, namely pin connectors 201p_{L}, 201pᵤ, 201n_{L}, 201nᵤ. As the pin connectors 201p_{L}, 201pᵤ, 201n_{L}, 201nᵤ are in contact with the corresponding electrically conductive plates 401p_{L}, 401pᵤ, 401n_{L}, 401nᵤ of the aerosolisation module 40, the electrical driving signal is conveyed to the upper and lower actuator assemblies 41U, 41L. In this manner, the elongate housing 20 is electrically coupled to the aerosolisation module 40, with the electrical driving signal fed to the upper and lower actuator assemblies 41U, 41L to induce vibration thereof.

Vibratory output from the upper and lower actuator assemblies 41U, 41L induces vibration of the membrane 42. Liquid aerosol-forming substrate is drawn from the reservoir 31 by the liquid feed 23 to the lower surface of the membrane 42. The vibrating action of the membrane 42 results in the substrate being ejected through the nozzles 44 as a pattern of aerosol droplets.

FIGS. 5a and 5b show perspective views of a second example of the aerosolisation module 40. FIG. 6 illustrates the aerosolisation module 40 of FIGS. 5a,b positioned in a cradle 50. The cradle 50 can slide in and out of the elongate housing 20 to provide detachable electrical connection between the housing 20 and the aerosolisation module 40. FIG. 7 provides a cross-section view through section B-B of FIG. 6 when the cradle 50 is fully inserted inside the housing 20.

The electrically-conductive contacts 401 of the aerosolisation module 40 of FIGS. 5a,b are formed of electrically-conductive plates 401p_{L}, 401pᵤ, 401n_{L}, 401nᵤ. However, in contrast to the aerosolisation module 40 of FIGS. 3a,b, for the module of FIGS. 5a,b the electrically conductive plates 401p_{L}, 401n L associated with the lower actuator assembly 41L and the electrically-conductive plates 401pᵤ, 401nᵤ associated with the upper actuator assembly 41U are formed on opposing surfaces of the vibratable transducer 41. The electrically conductive plates 401p_{L}, 401n_{L} are arranged on the lowermost surface of the lower actuator assembly 41L, whereas the electrically-conductive plates 401pᵤ, 401nᵤ are arranged on the uppermost surface of the upper actuator assembly 41U. The plates 401p_{L}, 401n L are connected to electrodes 46L of the lower actuator assembly 41L. Similarly, plates 401pᵤ and 401nᵤ are connected to electrodes 46U of the upper actuator assembly 41U. The plates 401p_{L}, 401n L and electrodes 46L serve to deliver the electrical driving signal generated by the controller 22 to the lower actuator assembly 41L of the vibratable transducer 41. Similarly, the plates 401pᵤ, 401nᵤ and electrodes 46U serve to deliver the electrical driving signal generated by the controller 22 to the upper actuator assembly 41L of the vibratable transducer 41. For the example shown, the plates 401p_{L}, 401pᵤ, 401n_{L}, 401nᵤ are formed of metal.

As shown in FIG. 6, an aperture 27 is formed in the sidewall of the cylindrical portion 20a of the housing 20. The aperture 27 defines an access opening for the cradle 50. The aerosolisation module 40 is positioned in the cradle 50. In an alternative example (not shown), the aerosolisation module 40 and the cradle 50 are provided with indexing features to provide a predetermined alignment between the aerosolisation module 40 and the cradle. Examples of suitable indexing features include mating lugs and recesses on the aerosolisation module 40 and the cradle 50.

The cradle 50 is slidably insertable into the housing 20 as shown in FIGS. 6 and 7. The cradle 50 is provided with lugs 51 (see FIG. 7). When the cradle 50 is slid out from the housing 20, the lugs 51 react against the inner surface of the sidewall of the housing 20, thereby preventing uncoupling of the cradle 50 from the housing 20. The electrically-conductive contacts 201 of the housing 20 take the form of pairs of sprung-loaded connectors 201p_{L}, 201n_{L} and 201pᵤ, 201nᵤ. Only one connector of each pair is visible in the view of FIG. 7. Each of the connectors 201p_{L}, 201n_{L}, 201pᵤ, 201nᵤ has an arm 202 extending from a root, with a spring 203 provided at the root so as to bias the connectors towards upper and lower surfaces of the aerosolisation module 40. Each pair of connectors 201p_{L}, 201n L and 201p u, 201nᵤ are connected to the controller 22 by electrical wiring or similar. Connectors 201p_{L}, 201n L are associated with providing the electrical driving signal generated by controller 22 to the lower actuator assembly 41L. Connectors 201pᵤ, 201nᵤ are associated with providing the electrical driving signal to the upper actuator assembly 41U. When the cradle 50 holding the aerosolisation module 40 is slid inside the housing 20, the lower pair of connectors 201p_{L}, 201n L are urged by the springs 203 against the electrically-conductive plates 401p_{L}, 401n L of the lower actuator assembly 41L and the upper pair of connectors 201pᵤ, 201nᵤ are similarly urged against electrically-conductive plates 401pᵤ, 401nᵤ of the upper actuator assembly 41U.

In use, the controller 22 accesses the memory module 22a and generates the electrical driving signal which is conveyed along the internal wiring or similar to the electrically-conductive contacts 201 of the housing 20, namely to the pairs of sprung-loaded connectors 201p_{L}, 201n_{L} and 201pᵤ, 201nᵤ. The upper pair of connectors 201pᵤ, 201nᵤ are urged against the plates 401pᵤ, 401nᵤ The lower pair of connectors 201p_{L}, 201n L are urged against the plates 401p_{L}, 401n L. In this manner, the elongate housing 20 is electrically coupled to the aerosolisation module 40, with the electrical driving signal fed to the upper and lower actuator assemblies 41U, 41L to induce vibration thereof. Vibratory output from the upper and lower actuator assemblies 41U, 41L induces vibration of the membrane 42. Liquid aerosol-forming substrate is drawn from the reservoir 31 by the liquid feed 23 to the lower surface of the membrane 42. The vibrating action of the membrane 42 results in the substrate being ejected through the nozzles 44 as a pattern of aerosol droplets.

FIG. 8 is a third example of an aerosolisation module 40, with FIG. 8 being a plan view of the membrane 42. The aerosolisation module 40 of FIG. 8 has a vibratable transducer 41 in the form of a single actuator assembly which is positioned against one surface of membrane 42. The membrane 42 has a first membrane portion 42a and a second membrane portion 42b, each membrane portion formed of metal. The first and second membrane portions 42a, 42b are electrically insulated from each other by an insulating strip 48. Region 401p of membrane portion 42a serves as an electrical contact region. Similarly, region 401n of membrane portion 42b also serves as an electrical contact region. Electrodes 46 are connected to regions 401p, 401n. In use, the electrically-conductive contacts 201 of the elongate housing 20 would contact the regions 401p, 401n to feed the electrical driving signal from the controller 22 to the vibratable transducer 41 of the aerosolisation module 40. The insulating strip 43 avoids a short circuit between regions 401p, 401n.

FIG. 9 is a schematic view of a second example of an aerosol-generating system 10. Features in common with the exemplary system of FIG. 1 are referred to using like-reference signs. The aerosol-generating system 10 of FIG. 9 differs from the system of FIG. 1 in that the controller 22 forms part of the aerosolisation module 40. As seen in FIG. 9, the controller 22 is coupled to a peripheral side surface of the vibratable transducer 41, with the electrically-conductive contacts 401 of the aerosolisation module coupled to or provided on a surface of the controller. When the aerosolisation module 40 is received in the elongate housing 20, the electrically-conductive contacts 201 of the housing 20 are in contact and electrical communication with the electrically-conductive contacts 401.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device, comprising:
an elongate housing, and
an aerosolisation module detachably insertable into the elongate housing, the aerosolisation module comprising:
a vibratable transducer configured to aerosolise a liquid aerosol-forming substrate,
one or more electrically conductive contacts in electrical communication with the vibratable transducer, wherein the one or more electrically conductive contacts are configured for detachable electrical connection with corresponding electrically conductive contacts of the elongate housing, and
a membrane comprising an aerosol generation zone, the vibratable transducer being operably coupled to the membrane so as to, in use, vibrate the membrane, wherein the membrane is formed of an electrically conductive material, and a portion of the membrane forms at least one of the one or more electrically conductive contacts of the aerosolisation module,
wherein the elongate housing contains a power source and is configured to detachably receive the aerosolisation module so as to establish a detachable electrical connection between the corresponding electrically conductive contacts of the elongate housing and the aerosolisation module such that the elongate housing is electrically coupled to the vibratable transducer,
wherein a sidewall of the elongate housing comprises an aperture, the aperture defining an access opening to a cavity extending within the elongate housing, the one or more electrically conductive contacts of the elongate housing being located in the cavity, and
wherein the corresponding electrically conductive contacts of the elongate housing and the aerosolisation module are configured such that insertion of the aerosolisation module into the cavity results in electrical connection between the corresponding contacts of the elongate housing and the aerosolisation module.

17. The aerosol-generating device according to claim 16, wherein at least one of the one or more electrically conductive contacts of the aerosolisation module forms part of the vibratable transducer.

18. The aerosol-generating device according to claim 16, wherein the aerosol generation zone is provided with a plurality of nozzles configured for passage there-through of liquid aerosol-forming substrate.

19. The aerosol-generating device according to claim 16,
wherein the one or more electrically conductive contacts of the aerosolisation module comprise a first electrically conductive contact and a second electrically conductive contact, and
wherein a first portion of the membrane forms the first electrically conductive contact and a second portion of the membrane forms the second electrically conductive contact.

20. The aerosol-generating device according to claim 16, wherein the vibratable transducer comprises at least one actuator.

21. The aerosol-generating device according to claim 16, wherein the vibratable transducer comprises an annular actuator assembly coupled to a surface of the membrane to encircle the aerosol generation zone, the annular actuator assembly comprising one or more actuators.

22. The aerosol-generating device according to claim 21, wherein the annular actuator assembly further comprises a single annular actuator.

23. The aerosol-generating device according to claim 21, wherein the annular actuator assembly further comprises two or more actuators arranged circumferentially relative to each other to define an annulus encircling the aerosol generation zone.

24. The aerosol-generating device according to claim 16,
wherein the vibratable transducer comprises a pair of annular actuator assemblies provided as a first annular actuator assembly and a second annular actuator assembly, each of the first and the second annular actuator assemblies comprising one or more actuators, the first and the second annular actuator assemblies being arranged to couple to opposing surfaces of the membrane such that an annulus of the membrane is confined between the first and the second annular actuator assemblies, the annulus encircling the aerosol generation zone, and
wherein the one or more electrically conductive contacts of the aerosolisation module comprise one or more first electrically conductive contacts in electrical communication with the first annular actuator assembly and one or more second electrically conductive contacts in electrical communication with the second annular actuator assembly.

25. The aerosol-generating device according to claim 24, wherein either or both of the first and the second annular actuator assemblies comprises a single annular actuator.

26. The aerosol-generating device according to claim 16, further comprising a cradle configured to receive the aerosolisation module, the cradle being removably insertable into the cavity via the access opening.

27. The aerosol-generating device according to claim 26, wherein the cradle and the aerosolisation module are keyed to each other such that the aerosolisation module is receivable in the cradle in a predetermined orientation.

28. The aerosol-generating device according to claim 26, wherein either or both of the cradle and the housing are further configured to prevent uncoupling of the cradle from the housing.

29. The aerosol-generating device according to claim 26, wherein the cradle is profiled to define a substantially flush fit with the sidewall of the elongate housing after insertion of the cradle into the cavity.

30. A kit of parts, the parts when assembled forming an aerosol-generating device, the parts comprising:
an elongate housing;
a first aerosolisation module; and
a second aerosolisation module,
each of the first and the second aerosolisation modules comprising:
a vibratable transducer configured to aerosolise a liquid aerosol-forming substrate,
one or more electrically conductive contacts in electrical communication with the vibratable transducer, wherein the one or more electrically conductive contacts are configured for detachable electrical connection with corresponding electrically conductive contacts of the elongate housing, and
a membrane comprising an aerosol generation zone, the vibratable transducer being operably coupled to the membrane so as to, in use, vibrate the membrane, wherein the membrane is formed of an electrically conductive material, and a portion of the membrane forms at least one of the one or more electrically conductive contacts of the first and the second aerosolisation modules,
wherein the elongate housing contains a power source and is configured to detachably receive one of the first and the second aerosolisation modules so as to establish a detachable electrical connection between the corresponding electrically conductive contacts of the elongate housing and the respective aerosolisation module such that the elongate housing is electrically coupled to the vibratable transducer,
wherein a sidewall of the elongate housing comprises an aperture, the aperture defining an access opening to a cavity extending within the elongate housing, the one or more electrically conductive contacts of the elongate housing located in the cavity, wherein the corresponding electrically conductive contacts of the elongate housing and the first and the second aerosolisation modules are configured such that insertion of the first and the second aerosolisation modules into the cavity results in electrical connection between the corresponding contacts of the elongate housing and the first and the second aerosolisation modules,
wherein the first and the second aerosolisation modules are interchangeable with each other in the elongate housing so as to be detachably received in the elongate housing, and
wherein the first aerosolisation module is further configured to generate a first aerosol emission pattern and the second aerosolisation module is further configured to generate a second aerosol emission pattern, the first and the second aerosol emission patterns being distinct from each other.
